(19) United States
(12) Patent Application Publication
(10) Pub. No.: US 2011/0011201 A1
(43) Pub. Date: Jan. 20, 2011

(54) Bicycle Bottom Bracket Assembly That Is Assembled Closely and Tightly

(76) Inventor: Yu-Sheng Kao, Tainan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/503,103

(22) Filed: Jul. 15, 2009

(51) Int. Cl. B62M 3/00

(52) U.S. Cl. 74/594.1

(57) ABSTRACT

A bottom bracket assembly for a bicycle includes a bottom bracket, two axles mounted on the bottom bracket and two cranks each having a mounting tube mounted on the respective axle. Each of the axles has a first engaging face, and the mounting tube of each of the cranks has a second engaging face engaging the first engaging face of the respective axle. Thus, the first engaging face extends through a partial portion of the circumference of each of the axles, and the second engaging face extends through a partial portion of the circumference of the mounting tube of each of the cranks to reduce the clearance between the mounting tube and the respective axle, so that the mounting tube of each of the cranks and the respective axle are combined together closely and tightly.

### BACKGROUND OF THE INVENTION

1. Field of the Invention

The present invention relates to a bottom bracket assembly and, more particularly, to a bottom bracket assembly for a bicycle.

2. Description of the Related Art

A conventional bottom bracket assembly for a bicycle in accordance with the prior art shown in FIGS. 7 and 8 comprises a bottom bracket 30, two axles 31 mounted on two opposite ends of the bottom bracket 30, and two cranks 40 mounted on the two axles 31 respectively. Each of the two axles 31 has an end face provided with a screw bore 33. Each of the two axles 31 has an outer wall provided with a plurality of axially extending grooves 32. The grooves 32 of each of the two axles 31 are arranged in an annular manner. Each of the two cranks 40 has an end portion provided with a mounting tube 41 mounted on the respective axle 31. The mounting tube 41 of each of the two cranks 40 has an inner wall provided with a plurality of axially extending ribs 42 secured in the grooves 32 of the respective axle 31. The ribs 42 of the mounting tube 41 of each of the two cranks 40 are arranged in an annular manner. The mounting tube 41 of each of the two cranks 40 has a forked side provided with two pressing ends 44 and a gap 43 defined between the two pressing ends 44. The pressing ends 44 of the mounting tube 41 of each of the cranks 40 are pressed toward each other by a tightening bolt 45 and a locking nut 46. The bottom bracket assembly further comprises two positioning bolts 34 each abutting the mounting tube 41 of a respective one of the two cranks 40 and each screwed into the screw bore 33 of a respective one of the axles 31.

In operation, when the tightening bolt 45 and the locking nut 46 are rotated and tightened, the two pressing ends 44 of the mounting tube 41 of each of the two cranks 40 are pressed toward each other to clamp and lock the mounting tube 41 of each of the two cranks 40 onto the respective axle 31. At this time, the ribs 42 of the mounting tube 41 of each of the two cranks 40 are secured in the grooves 32 of the respective axle 31 so that the mounting tube 41 of each of the two cranks 40 is positioned on the respective axle 31 exactly to prevent the mounting tube 41 of each of the two cranks 40 from being rotated relative to the respective axle 31.

However, when the two pressing ends 44 of the mounting tube 41 of each of the two cranks 40 are pressed toward each other to lock the mounting tube 41 of each of the two cranks 40 onto the respective axle 31, the stress is concentrated on the two opposite sides of the gap 43 to produce a clearance between the ribs 42 of the mounting tube 41 of each of the two cranks 40 and the grooves 32 of the respective axle 31 as shown in FIG. 8 so that so that the mounting tube 41 of each of the two cranks 40 and the respective axle 31 are not combined together closely and tightly. In addition, the outer wall of each of the two axles 31 is worked completely to form the grooves 32, and the inner wall of the mounting tube 41 of each of the two cranks 40 is worked completely to form the ribs 42 so that the bottom bracket assembly has a higher cost of fabrication. Further, the grooves 32 of each of the axles 31 are arranged in an annular manner, and the ribs 42 of the mounting tube 41 of each of the cranks 40 are arranged in an annular manner, so that the mounting tubes 41 of the two cranks 40 are easily misaligned with the two axles 31, thereby causing inconvenience in assembly of the bottom bracket assembly.

### BRIEF SUMMARY OF THE INVENTION

In accordance with the present invention, there is provided a bottom bracket assembly for a bicycle, comprising a bottom bracket, two axles mounted on two opposite ends of the bottom bracket and two cranks mounted on the two axles respectively and each having an end portion provided with a mounting tube mounted on the respective axle. Each of the two axles has an outer wall provided with a first engaging face. The first engaging face of each of the two axles extends through a length of about one quarter to one half of a circumferential length of each of the two axles. The mounting tube of each of the two cranks has an inner wall provided with a second engaging face engaging the first engaging face of the respective axle. The second engaging face of the mounting tube of each of the two cranks extends through a length of about one quarter to one half of a circumferential length of the mounting tube of each of the two cranks.

The primary objective of the present invention is to provide a bicycle bottom bracket assembly that is assembled closely and tightly.

Another objective of the present invention is to provide a bottom bracket assembly for a bicycle, wherein the first engaging face extends through a partial portion of the circumference of each of the two axles, and the second engaging face extends through a partial portion of the circumference of the mounting tube of each of the two cranks to largely reduce the clearance between the mounting tube of each of the two cranks and the respective axle, so that the mounting tube of each of the two cranks and the respective axle are combined together closely and tightly to enhance the structural strength of the bottom bracket assembly.

A further objective of the present invention is to provide a bottom bracket assembly for a bicycle, wherein each of the two axles is worked locally to form the first engaging face, and the mounting tube of each of the two cranks is worked locally to form the second engaging face so that the bottom bracket assembly has a largely simplified construction with a lower cost of fabrication.

A further objective of the present invention is to provide a bottom bracket assembly for a bicycle, wherein the first engaging faces of the two axles are located at two opposite positions and are directed toward two different directions so that the mounting tube of each of the two cranks is mounted on the respective axle easily and quickly, thereby greatly facilitating assembly of the bottom bracket assembly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a bottom bracket assembly for a bicycle in accordance with the preferred embodiment of the present invention.

FIG. 2 is an exploded perspective view of the bottom bracket assembly for a bicycle as shown in FIG. 1.

FIG. 3 is a partially front cross-sectional view of the bottom bracket assembly for a bicycle as shown in FIG. 1.

FIG. 4 is a side cross-sectional view of the bottom bracket assembly for a bicycle as shown in FIG. 1.

FIG. 5 is a side cross-sectional view of a bottom bracket assembly for a bicycle in accordance with another preferred embodiment of the present invention.

FIG. 6 is a side cross-sectional view of a bottom bracket assembly for a bicycle in accordance with another preferred embodiment of the present invention.

FIG. 7 is an exploded perspective view of a conventional bottom bracket assembly for a bicycle in accordance with the prior art.

FIG. 8 is a side cross-sectional assembly view of the conventional bottom bracket assembly for a bicycle as shown in FIG. 7.

### DETAILED DESCRIPTION OF THE INVENTION

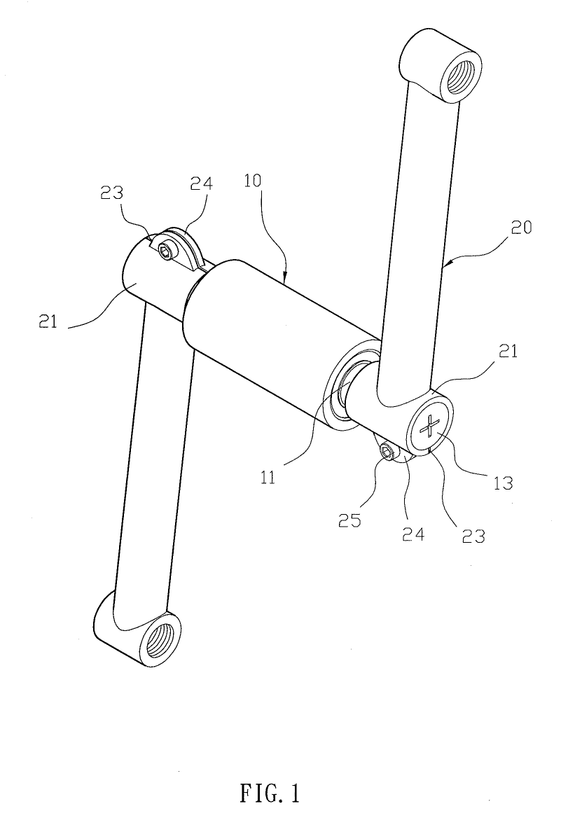

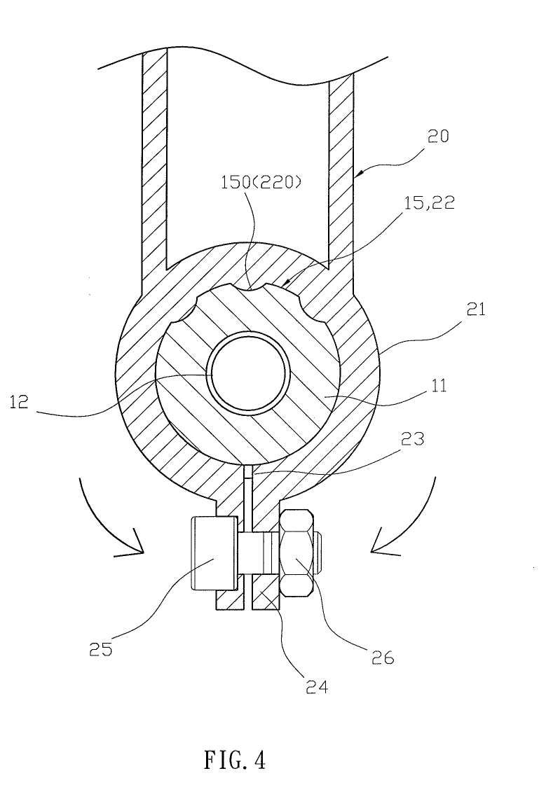

Referring to the drawings and initially to FIGS. 1-4, a bottom bracket assembly for a bicycle in accordance with the preferred embodiment of the present invention comprises a bottom bracket 10, two axles 11 mounted on two opposite ends of the bottom bracket 10, and two cranks 20 mounted on the two axles 11 respectively.

Each of the two axles 11 has an end face provided with a screw bore 12. Each of the two axles 11 has an outer wall provided with a first engaging face 15. The first engaging face 15 of each of the two axles 11 extends through a length of about one quarter to one half of a circumferential length of each of the two axles 11. The first engaging face 15 of each of the two axles 11 is arranged to have a substantially arc-shaped profile. The first engaging face 15 of each of the two axles 11 consists of a plurality of axially extending grooves 150. The first engaging faces 15 of the two axles 11 are located at two opposite positions and are directed toward two different directions. Preferably, the first engaging face 15 of a first one of the two axles 11 is located opposite to the first engaging face 15 of a second one of the two axles 11.

Each of the two cranks 20 has an end portion provided with a mounting tube 21 mounted on the respective axle 11. The mounting tube 21 of each of the two cranks 20 has an inner wall provided with a second engaging face 22 engaging the first engaging face 15 of the respective axle 11. The second engaging face 22 of the mounting tube 21 of each of the two cranks 20 extends through a length of about one quarter to one half of a circumferential length of the mounting tube 21 of each of the two cranks 20. The second engaging face 22 of the mounting tube 21 of each of the two cranks 20 is arranged to have a substantially arc-shaped profile. The second engaging face 22 of the mounting tube 21 of each of the two cranks 20 consists of a plurality of axially extending ribs 220. The second engaging face 22 of the mounting tube 21 of each of the two cranks 20 is distributed at a position of intersection between the mounting tube 21 and each of the two cranks 20.

The mounting tube 21 of each of the two cranks 20 has a forked side provided with two pressing ends 24 and a gap 23 defined between the two pressing ends 24. The two pressing ends 24 of the mounting tube 21 of each of the two cranks 20 are located opposite to the second engaging face 22 and are pressed toward each other by a tightening bolt 25 and a locking nut 26. The gap 23 of the mounting tube 21 of each of the two cranks 20 aligns with a middle portion of the second engaging face 22.

The bottom bracket assembly further comprises two positioning bolts 13 each abutting an end portion of the mounting tube 21 of a respective one of the two cranks 20 and each screwed into the screw bore 12 of a respective one of the axles 11.

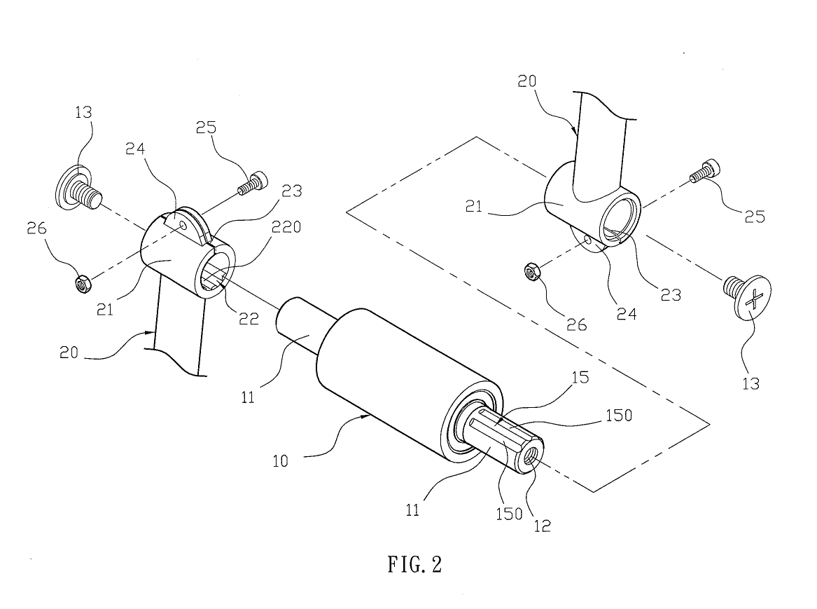

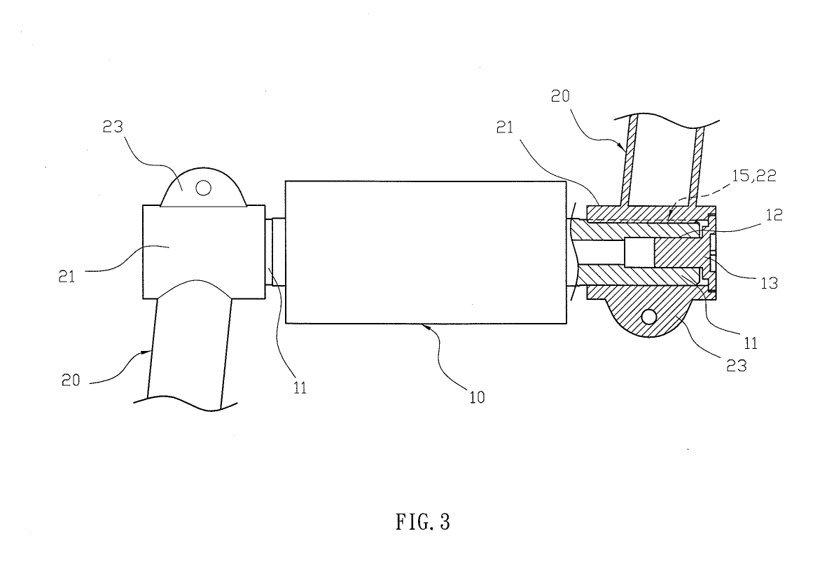

In operation, referring to FIG. 3 with reference to FIGS. 1 and 2, when the tightening bolt 25 and the locking nut 26 are rotated and tightened, the two pressing ends 24 of the mounting tube 21 of each of the two cranks 20 are pressed toward each other to clamp and lock the mounting tube 21 of each of the two cranks 20 onto the respective axle 11. At this time, the second engaging face 22 of the mounting tube 21 of each of the two cranks 20 engages the first engaging face 15 of the respective axle 11 so that the mounting tube 21 of each of the two cranks 20 is positioned on the respective axle 11 exactly to prevent the mounting tube 21 of each of the two cranks 20 from being rotated relative to the respective axle 11.

Accordingly, the first engaging face 15 extends through a partial portion of the circumference of each of the two axles 11, and the second engaging face 22 extends through a partial portion of the circumference of the mounting tube 21 of each of the two cranks 20 to largely reduce the clearance between the mounting tube 21 of each of the two cranks 20 and the respective axle 11, so that the mounting tube 21 of each of the two cranks 20 and the respective axle 11 are combined together closely and tightly to enhance the structural strength of the bottom bracket assembly. In addition, each of the two axles 11 is worked locally to form the first engaging face 15, and the mounting tube 21 of each of the two cranks 20 is worked locally to form the second engaging face 22 so that the bottom bracket assembly has a largely simplified construction with a lower cost of fabrication. Further, the first engaging faces 15 of the two axles 11 are located at two opposite positions and are directed toward two different directions so that the mounting tube 21 of each of the two cranks 20 is mounted on the respective axle 11 easily and quickly, thereby greatly facilitating assembly of the bottom bracket assembly.

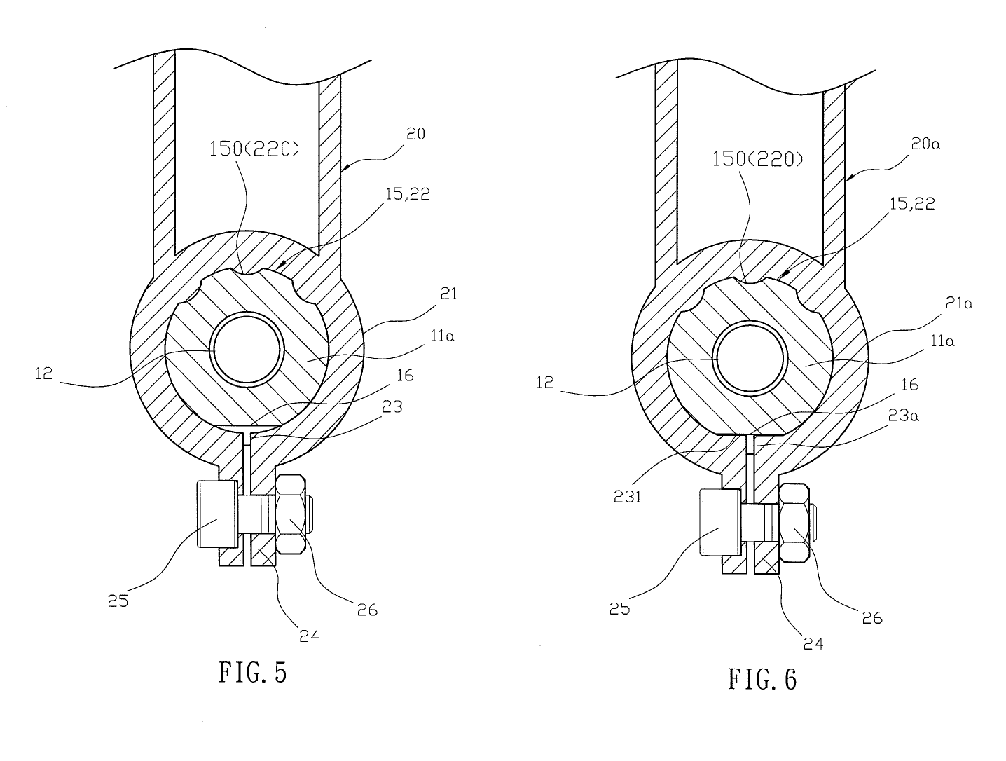

Referring FIG. 5, the outer wall of each of the two axles 11a is provided with a flattened face 16. The flattened face 16 of each of the two axles 11a is located opposite to the first engaging face 15, and the gap 23 of the mounting tube 21 of each of the two cranks 20 aligns with the flattened face 16 of the respective axle 11a. Thus, when the two pressing ends 24 of the mounting tube 21 of each of the two cranks 20 are pressed toward each other, the gap 23 of the mounting tube 21 of each of the two cranks 20 is contracted toward the flattened face 16 of the respective axle 11a to increase the connection between the mounting tube 21 of each of the two cranks 20 and the respective axle 11a.

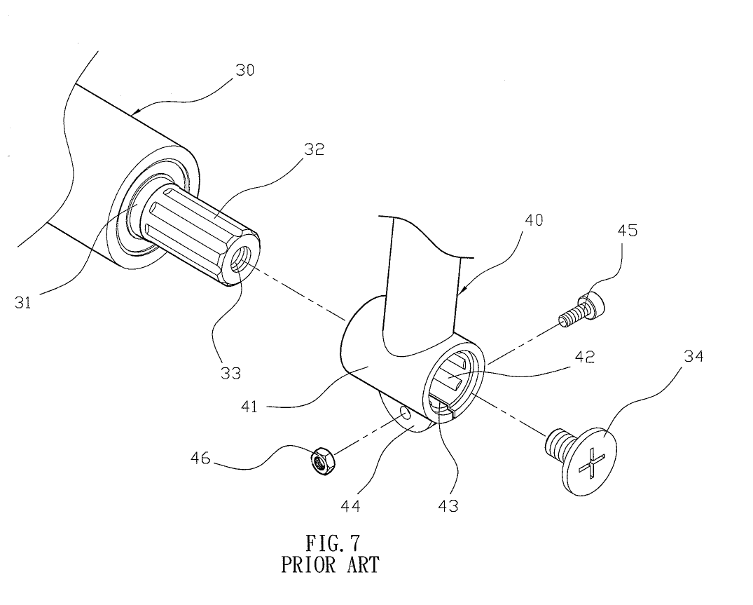

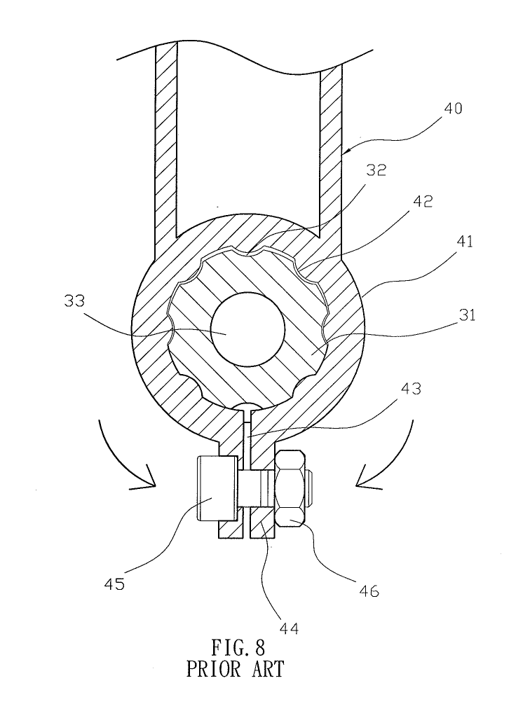

Referring FIG. 6, the gap 23a of the mounting tube 21 a of each of the two cranks 20a has a side provided with a flattened surface 231 abutting the flattened face 16 of the respective axle 11a. The flattened surface 231 of the mounting tube 21a of each of the two cranks 20a is located opposite to the second engaging face 22.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A bottom bracket assembly for a bicycle, comprising:
a bottom bracket;
two axles mounted on two opposite ends of the bottom bracket;
two cranks mounted on the two axles respectively and each having an end portion provided with a mounting tube mounted on the respective axle; wherein
each of the two axles has an outer wall provided with a first engaging face;
the first engaging face of each of the two axles extends through a length of about one quarter to one half of a circumferential length of each of the two axles;
the mounting tube of each of the two cranks has an inner wall provided with a second engaging face engaging the first engaging face of the respective axle;
the second engaging face of the mounting tube of each of the two cranks extends through a length of about one quarter to one half of a circumferential length of the mounting tube of each of the two cranks.

2. The bottom bracket assembly for a bicycle of claim 1, wherein the first engaging faces of the two axles are located at two opposite positions.

3. The bottom bracket assembly for a bicycle of claim 1, wherein the first engaging faces of the two axles are directed toward two different directions.

4. The bottom bracket assembly for a bicycle of claim 1, wherein the first engaging face of each of the two axles is arranged to have a substantially arc-shaped profile;
the second engaging face of the mounting tube of each of the two cranks is arranged to have a substantially arc-shaped profile.

5. The bottom bracket assembly for a bicycle of claim 2, wherein the first engaging face of a first one of the two axles is located opposite to the first engaging face of a second one of the two axles.

6. The bottom bracket assembly for a bicycle of claim 1, wherein the second engaging face of the mounting tube of each of the two cranks is distributed at a position of intersection between the mounting tube and each of the two cranks.

7. The bottom bracket assembly for a bicycle of claim 1, wherein
the first engaging face of each of the two axles consists of a plurality of axially extending grooves;
the second engaging face of the mounting tube of each of the two cranks consists of a plurality of axially extending ribs.

8. The bottom bracket assembly for a bicycle of claim 1, wherein the mounting tube of each of the two cranks has a forked side provided with two pressing ends and a gap defined between the two pressing ends.

9. The bottom bracket assembly for a bicycle of claim 8, wherein the two pressing ends of the mounting tube of each of the two cranks are located opposite to the second engaging face.

10. The bottom bracket assembly for a bicycle of claim 8, wherein the gap of the mounting tube of each of the two cranks aligns with a middle portion of the second engaging face.

11. The bottom bracket assembly for a bicycle of claim 8, wherein
the outer wall of each of the two axles is provided with a flattened face;
the gap of the mounting tube of each of the two cranks aligns with the flattened face of the respective axle.

12. The bottom bracket assembly for a bicycle of claim 11, wherein the flattened face of each of the two axles is located opposite to the first engaging face.

13. The bottom bracket assembly for a bicycle of claim 11, wherein the gap of the mounting tube of each of the two cranks is contracted toward the flattened face of the respective axle when the two pressing ends of the mounting tube of each of the two cranks are pressed toward each other.

14. The bottom bracket assembly for a bicycle of claim 11, wherein the gap of the mounting tube of each of the two cranks has a side provided with a flattened surface abutting the flattened face of the respective axle.

15. The bottom bracket assembly for a bicycle of claim 14, wherein the flattened surface of the mounting tube of each of the two cranks is located opposite to the second engaging face.
